(19) United States
(12) Patent Application Publication
(10) Pub. No.: US 2024/0385503 A1
(43) Pub. Date: Nov. 21, 2024

(54) ALIGNMENT MODULE

(71) Applicant: QISDA CORPORATION, Taoyuan City (TW)

(72) Inventors: Jia-Ming Zhang, Taichung City (TW); Ching-Tze Huang, Taoyuan City (TW); Tsung-Hsun Wu, Taoyuan City (TW)

(73) Assignee: QISDA CORPORATION, Taoyuan City (TW)

(21) Appl. No.: 18/655,315

(22) Filed: May 5, 2024

(30) Foreign Application Priority Data
May 15, 2023 (CN) 202310540976.7

(51) Int. Cl. G03B 21/20; G02B 26/00

(52) U.S. Cl. CPC G03B 21/2073; G03B 21/204; G03B 21/208; G02B 26/008

(57) ABSTRACT

An alignment module includes a light source module, a collimator lens, a wavelength transformation module, a polarizing beamsplitter and a quarter wave plate. The light source module provides a first illumination beam with a first polarization state. The wavelength transformation module receives the first illumination beam to generate an actuation beam and reflect the first illumination beam. The polarizing beamsplitter is disposed between the light source module and the collimator lens and allows passing of the actuation beam. The quarter wave plate is disposed on a downstream of the polarizing beamsplitter. The first illumination beam with the first polarization state is transformed into a second illumination beam with a second polarization state via the quarter wave plate.

### BACKGROUND OF THE INVENTION

### 1. Field of the Invention

The present invention relates to an alignment module, and more particularly, to an alignment module applied for a projection apparatus and having fewer optical components for cost reduction.

### 2. Description of the Prior Art

The conventional laser projector utilizes the blue light laser source to provide the illumination beam. The illumination beam is transformed into an excitation beam with different color via the wavelength conversion device (such as the color wheel partly covered by phosphor powder or quantum dot material); then, the excitation beam is mixed with the illumination beam for related application. The conventional alignment module utilizes the dichroic component to reflect the illumination beam toward the color wheel. A portion of the color wheel made by wavelength conversion material generates the excitation beam accordingly, and the excitation beam can pass through the dichroic component. Besides, a part of the illumination beam passes through another portion of the color wheel without the wavelength conversion material and moves back the dichroic component via reflecting components, and then is reflected by the dichroic component to mix with the excitation beam. Therefore, the conventional alignment module has drawbacks of expensive hardware cost and heavy weight due to a large number of optical components.

### SUMMARY OF THE INVENTION

The present invention provides an alignment module applied for a projection apparatus and having fewer optical components for cost reduction for solving above drawbacks.

According to the claimed invention, an alignment module includes a light source module, a collimator lens, a wavelength transformation module, a polarizing beamsplitter and a quarter wave plate. The light source module is adapted to emit a first illumination beam with a first polarization state in a first direction. The collimator lens has a first part, a second part, and an axle located between the first part and the second part. The wavelength transformation module is adapted to receive the first illumination beam from the collimator lens, so as to alternately generate an actuation beam and reflect the first illumination beam. The actuation beam is transmitted towards the collimator lens in a second direction, and the first illumination beam is reflected towards the collimator lens in the second direction; the second direction being perpendicular to the first direction. The polarizing beamsplitter is disposed on position corresponding to at least one of the first part and the second part, and adapted to reflect the first illumination beam with the first polarization state and allow passing of the actuation beam. The quarter wave plate is disposed between the polarizing beamsplitter and the wavelength transformation module. The first illumination beam with the first polarization state passes through the quarter wave plate towards the wavelength transformation module, and is reflected by the wavelength transformation module to pass through the quarter wave plate so as to transform into a second illumination beam with a second polarization state.

According to the claimed invention, the polarizing beamsplitter is disposed on position corresponding to the first part and the second part, and is adapted to reflect the first illumination beam and allow passing of the second illumination beam, the first illumination beam passes through the collimator lens towards the wavelength transformation module in a direction opposite to the second direction, and the first illumination beam is reflected in the second direction to pass through the first part and the second part of the collimator lens. Or, the polarizing beamsplitter is disposed on position corresponding to the first part and is adapted to reflect the first illumination beam, the first illumination beam passes through the first part of the collimator lens towards the wavelength transformation module in a direction opposite to the second direction, and the first illumination beam is reflected in the second direction to pass through the second part of the collimator lens.

According to the claimed invention, the quarter wave plate is disposed on position corresponding to the first part and the second part, and further disposed between the polarizing beamsplitter and the collimator lens; or, the quarter wave plate is disposed on position corresponding to the first part and the second part, and further disposed between the collimator lens and the wavelength transformation module; or, the quarter wave plate is disposed on a reflection region of the wavelength transformation module.

The alignment module of the present invention can utilize feature of the illumination beam with a specific polarization state passing through the quarter wave plate twice to transform into the illumination beam with another polarization state, and feature of the quarter wave plate that allows passing of the actuation beam with the small-sized polarizing beamsplitter (which simultaneously corresponds to the left portion and the right portion of the collimator lens) to pass the illumination beam through the quarter wave plate back and forth for the double transformation, so as to provide light splitting and mixing functions via the polarizing beamsplitter for decreasing a number of optical components and manufacturing cost of the projection apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 4 are diagrams of an alignment module according to different embodiments of the present invention.

FIG. 5 is a diagram of the wavelength transformation module according to the embodiment of the present invention.

FIG. 6 is a diagram of the wavelength transformation module according to another embodiment of the present invention.

FIG. 7 is a diagram of the wavelength transformation module according to another embodiment of the present invention.

### DETAILED DESCRIPTION

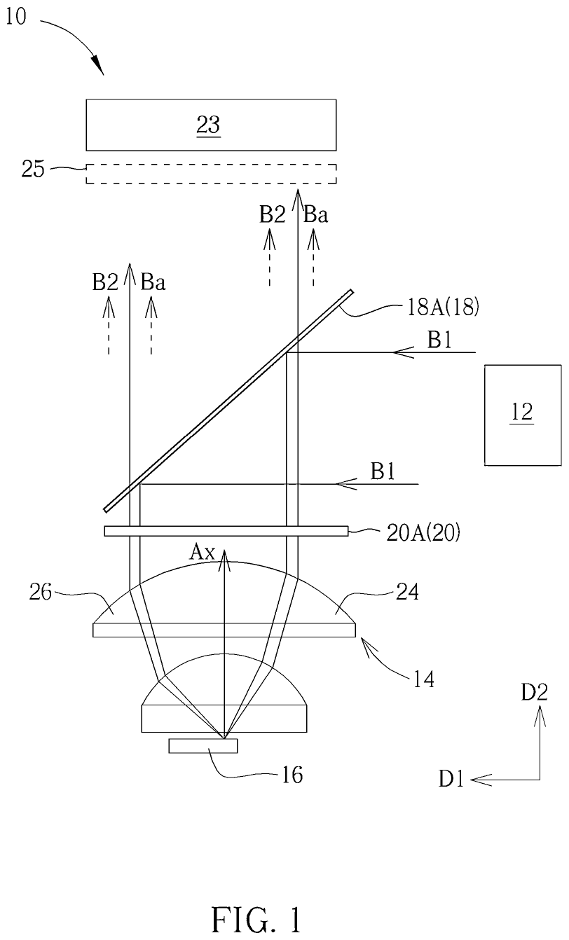

Please refer to FIG. 1 to FIG. 4. FIG. 1 to FIG. 4 are diagrams of an alignment module 10 according to different embodiments of the present invention. The alignment module 10 can include a light source module 12, a collimator lens 14, a wavelength transformation module 16, a polarizing beamsplitter 18, a quarter wave plate 20 and an optical diffuser 23. The light source module 12 can emit a first illumination beam B1 with a first polarization state towards the polarizing beamsplitter 18 in a first direction D1. The first illumination beam B1 can be set in a first waveband (such as the blue light waveband). The collimator lens 14 can have a first part 24, a second part 26, and an axle Ax located between the first part 24 and the second part 26. The axle Ax can be a central axle o the collimator lens 14. The collimator lens 14 can be disposed between the polarizing beamsplitter 18 and the wavelength transformation module 16. A number of the collimator lens 14 can be at least one, and an actual value of the foresaid number can depend on a design demand. The polarizing beamsplitter 18 can be disposed between the light source module 12 and the collimator lens 14, and further disposed on position corresponding to the first part 24 and/or the second part 26 of the collimator lens 14.

The wavelength transformation module 16 can receive the first illumination beam B1 from the collimator lens 14, and be adapted to alternately generate an actuation beam Ba transmitted towards the collimator lens 14 in a second direction D2 and further to reflect the first illumination beam B1 from the quarter wave plate 20 in the second direction D2; generally, the second direction D2 can be substantially perpendicular to the first direction D1. The quarter wave plate 20 can be disposed between the polarizing beamsplitter 18 and the wavelength transformation module 16. The first illumination beam B1 with the first polarization state can pass through the quarter wave plate 20 towards the wavelength transformation module 16, and be reflected by the wavelength transformation module 16 to pass through the quarter wave plate 20, so as to be transformed into a second illumination beam B2 with a second polarization state. In any of the embodiments of the present invention, elements having the same numerals as ones of the other embodiments can have the same structures and functions, and a detailed description is omitted herein for simplicity. The present invention may assign different numbers to the elements with different features in different embodiments.

As the embodiment shown in FIG. 1, the polarizing beamsplitter 18A of the alignment module 10 can be disposed on position corresponding to the first part 24 and the second part 26 of the collimator lens 14. The quarter wave plate 20A of the alignment module 10 can be disposed between the polarizing beamsplitter 18A and the collimator lens 14. The polarizing beamsplitter 18A can reflect the first illumination beam B1 with the first polarization state to pass through the first part 24 and the second part 26 of the collimator lens 14, and further allow passing of the second illumination beam B2 with the second polarization state and the actuation beam Ba without the polarization state from the first part 24 and the second part 26 of the collimator lens 14. The quarter wave plate 20A can be disposed on the position corresponding to the first part 24 and the second part 26 of the collimator lens 14.

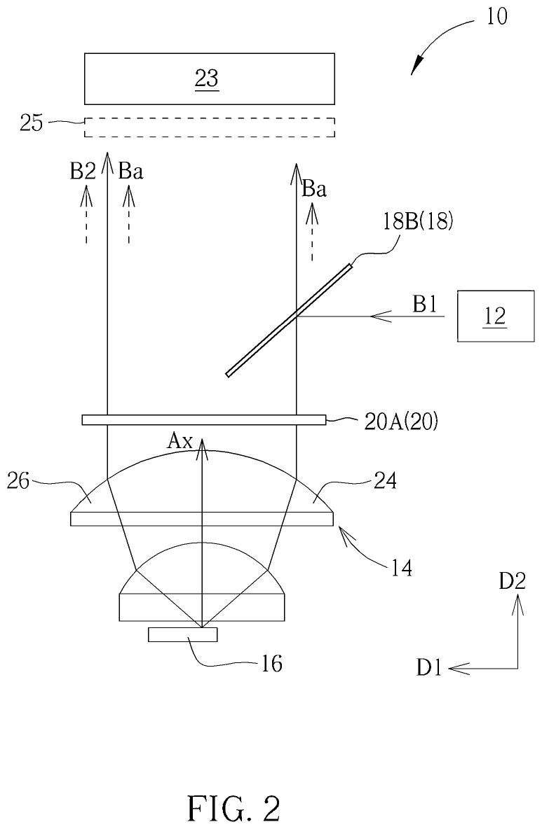

As the embodiment shown in FIG. 2, the polarizing beamsplitter 18B of the alignment module 10 can be disposed on position corresponding to at least one of the first part 24 and the second part 26 of the collimator lens 14; for example, the polarizing beamsplitter 18B shown in FIG. 2 can be disposed on the position corresponding to the first part 24. The quarter wave plate 20A of the alignment module 10 can be disposed between the polarizing beamsplitter 18B and the collimator lens 14, and further disposed on the position corresponding to the first part 24 and the second part 26 of the collimator lens 14. The polarizing beamsplitter 18B can reflect the first illumination beam B1 with the first polarization state to pass through one part of the collimator lens 14 (such as the first part 24 shown in FIG. 2). The actuation beam Ba alternately generated by the wavelength transformation module 16 can pass through the first part 24 and the second part 26 of the collimator lens 14. The actuation beam Ba from the foresaid part of the collimator lens 14 (such as the first part 24 shown in FIG. 2) can further pass through the polarizing beamsplitter 18B. The first illumination beam B1 alternately reflected by the wavelength transformation module 16 can pass through the quarter wave plate 20 to transform into the second illumination beam B2 with the second polarization state. The second illumination beam B2 can pass through the other part of the collimator lens 14, such as the second part 26 shown in FIG. 2.

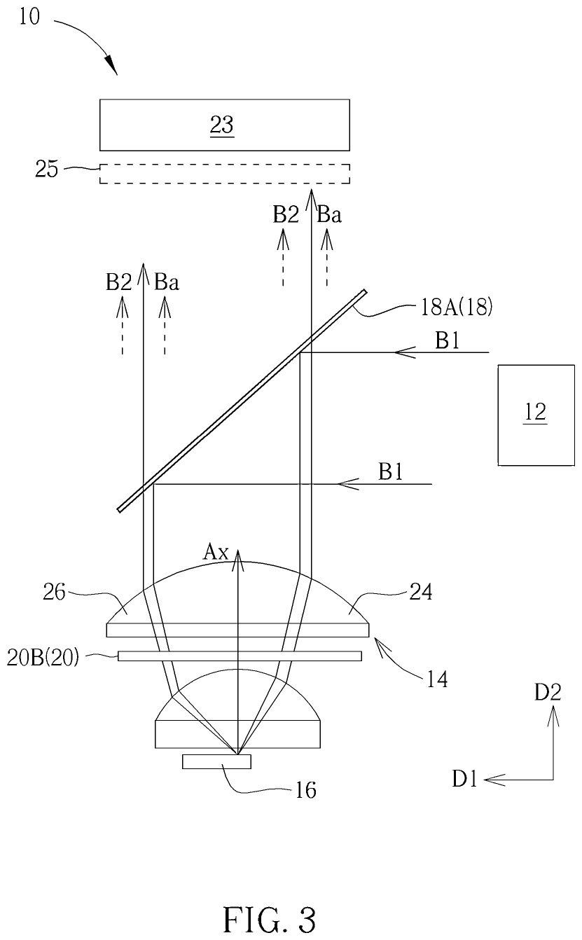

As the embodiment shown in FIG. 3, the polarizing beamsplitter 18A of the alignment module 10 can be disposed on the position corresponding to the first part 24 and the second part 26 of the collimator lens 14, or can be disposed on the position corresponding to one of the first part 24 and the second part 26 of the collimator lens 14 (such as the polarizing beamsplitter 18B shown in FIG. 2). The quarter wave plate 20B of the alignment module 10 can be disposed between the collimator lens 14 and the wavelength transformation module 16, and further on the position corresponding to the first part 24 and the second part 26 of the collimator lens 14. The first illumination beam B1 can be reflected by the polarizing beamsplitter 18A to pass through the first part 24 and the second part 26 of the collimator lens 14, and then further pass through all parts of the quarter wave plate 20B towards the wavelength transformation module 16, or may be reflected by the polarizing beamsplitter 18B to pass through one part of the collimator lens 14 and then pass through some part of the quarter wave plate 20B towards the wavelength transformation module 16. The first illumination beam B1 (which has a polarization state different from the first polarization state due to one pass of the quarter wave plate 20B) alternately reflected by the wavelength transformation module 16 can pass through the quarter wave plate 20B a second time for transforming into the second illumination beam B2 with the second polarization state which is transmitted in the second direction D2. The actuation beam Ba alternately generated by the wavelength transformation module 16 can pass through the first part 24 and the second part 26 of the collimator lens 14.

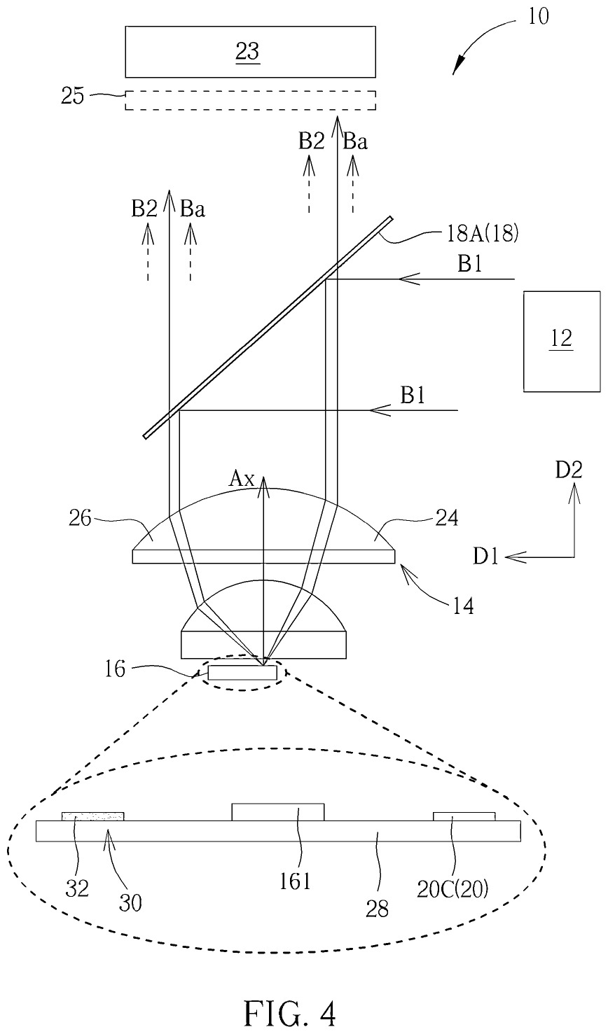

As the embodiment shown in FIG. 4, the polarizing beamsplitter 18A of the alignment module 10 can be disposed on the position corresponding to the first part 24 and the second part 26 of the collimator lens 14, or can be disposed on the position corresponding to one of the first part 24 and the second part 26 of the collimator lens 14 (such as the polarizing beamsplitter 18B shown in FIG. 2). The quarter wave plate 20C of the alignment module 10 can be disposed on a reflection region 28 of the wavelength transformation module 16. The wavelength transformation module 16 can be rotated via the central shaft 161. The reflection region 28 and a first region 30 (or other region having the wavelength transformation layer) can be disposed around the central shaft 161. In the embodiment, the quarter wave plate 20C can be directly disposed on the reflection region 28, and the first wavelength transformation layer 32 can be accordingly disposed on the first region 30; other wavelength transformation layer is disposed on other region accordingly. The axle Ax of the collimator lens 14 can point towards the quarter wave plate 20C of the reflection region 28 or the first wavelength transformation layer 32 on the first region 30 in accordance with rotation of the wavelength transformation module 16.

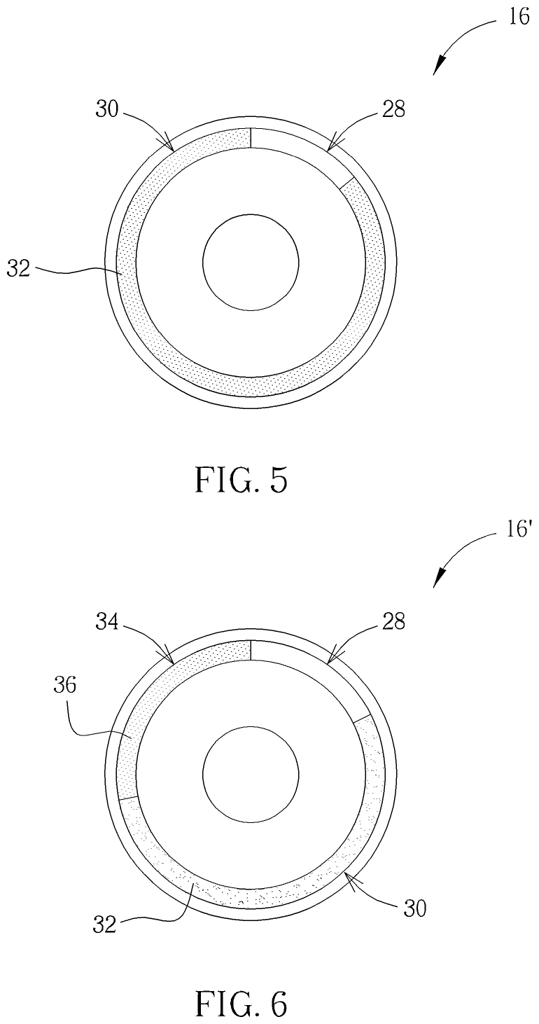

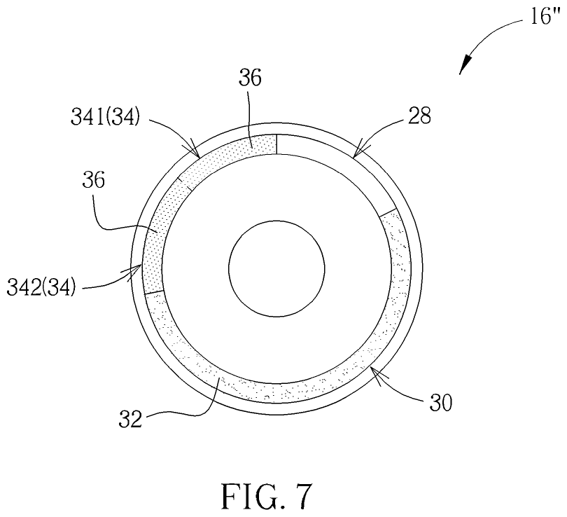

Please refer to FIG. 5 to FIG. 7. FIG. 5 is a diagram of the wavelength transformation module 16 according to the embodiment of the present invention. FIG. 6 is a diagram of the wavelength transformation module 16′ according to another embodiment of the present invention. FIG. 7 is a diagram of the wavelength transformation module 16″ according to another embodiment of the present invention. As shown in FIG. 5, the wavelength transformation module 16 can have the reflection region 28 and the first region 30 disposed adjacent to each other. The reflection region 28 can reflect the first illumination beam B1 incident from the first part 24 of the collimator lens 14 towards the second part 26 of the collimator lens 14. The first region 30 can have a first wavelength transformation layer 32 (such as yellow wavelength transformation made by a yellow phosphor layer) adapted to receive the first illumination beam B1 and generate the actuation beam Ba in the second waveband (such as the yellow light waveband). When the wavelength transformation module 16 is applied to the embodiment shown in FIG. 1, a filtering layer with a specific filter effect can be coated on the polarizing beamsplitter 18A, and the polarizing beamsplitter 18A cooperated with the wavelength transformation module 16 can allow passing of the blue light and the yellow light, and the color wheel 25 can be accordingly applied to decompose the yellow light into the green light and the red light, so as to achieve a three color light effect of the blue light, the red light and the green light by one kind of phosphor powder. When the wavelength transformation module 16 is applied to the embodiment shown in FIG. 2, the second illumination beam B2 does not pass through the polarizing beamsplitter 18B, and the polarizing beamsplitter 18B does not have the filtering layer that allows passing of the blue light; then, the color wheel 25 can be applied to decompose the yellow light into the green light and the red light, so as to achieve the three color light effect of the blue light, the red light and the green light.

As shown in FIG. 6, the wavelength transformation module 16′ can have the reflection region 28, the first region 30 and a second region 34 disposed adjacent to each other. Functions of the reflection region 28 and the first region 30 are the same as ones of the foresaid embodiment, and the detailed description is omitted herein for simplicity. The first wavelength transformation layer 32 of the first region 30 can be the yellow wavelength transformation material made by the yellow phosphor layer. The second region 34 can have a second wavelength transformation layer 36 (such as green wavelength transformation material made by a green phosphor layer). The first wavelength transformation layer 32 and the second wavelength transformation layer 36 can be used to receive the first illumination beam B1 and generate the actuation beam Ba in the second waveband (such as the yellow light waveband and the green light waveband). If the wavelength transformation module 16′ is applied to the embodiment show in FIG. 1, the filtering layer with the specific filter effect can be coated on the polarizing beamsplitter 18A, and the polarizing beamsplitter 18A that is cooperated with the wavelength transformation module 16′ can allow passing of the blue light, the green light and the yellow light, and the color wheel 25 can be accordingly applied to decompose the yellow light into the red light, so as to achieve the three color light effect of the blue light, the red light and the green light. When the wavelength transformation module 16′ is applied to the embodiment shown in FIG. 2, the second illumination beam B2 does not pass through the polarizing beamsplitter 18B, and the polarizing beamsplitter 18B does not have the filtering layer that allows passing of the blue light; then, the color wheel 25 can be applied to decompose the yellow light into the green light and the red light, so as to achieve the three color light effect of the blue light, the red light and the green light.

As shown in FIG. 7, the wavelength transformation module 16″ can have the reflection region 28, the first region 30 and the second region 34 disposed adjacent to each other. Functions of the reflection region 28 are the same as ones of the foresaid embodiment, and the detailed description is omitted herein for simplicity. The first wavelength transformation layer 32 of the first region 30 can include the green wavelength transformation material used to generate the actuation beam Ba in the second waveband for providing the green light beam. The second region 34 can be divided into two sub-regions 341 and 342 respectively having the second wavelength transformation layer 36 with the red wavelength transformation material and/or the second wavelength transformation layer 36 with the orange wavelength transformation material, so as to generate the actuation beam Ba in the second waveband for providing the red light beam or the orange light beam. If the wavelength transformation module 16″ is applied to the embodiment show in FIG. 1, the filtering layer with the specific filter effect can be coated on the polarizing beamsplitter 18A, and the polarizing beamsplitter 18A that is cooperated with the wavelength transformation module 16″ can allow passing of the blue light, the green light and the red light (or the orange light), so that the color wheel is unnecessary (which means the color wheel 25 may be removed from the embodiment shown in FIG. 1) and the three color light effect of the blue light, the red light and the green light can be achieved, and therefore the foresaid embodiment can have advantages of economizing component cost and configuration space. When the wavelength transformation module 16″ is applied to the embodiment shown in FIG. 2, the second illumination beam B2 does not pass through the polarizing beamsplitter 18B, and the polarizing beamsplitter 18B does not have the filtering layer that allows passing of the blue light; then, the second illumination beam B2 (such as in the blue light waveband) and the actuation beam Ba (such as in the green light waveband, and the red light waveband or the orange light waveband) can be directly received by the optical diffuser 23, so as to achieve the three color light effect of the blue light, the red light and the green light without the color wheel for having the advantages of economizing the component cost and the configuration space.

That is, the first illumination beam B1 can be set in the first waveband (such as the blue light waveband) to provide the blue light beam in the first polarization state (such as the S polarization state). The first illumination beam B1 can be transformed into the second illumination beam B2 set in the first waveband and with the second polarization state (such as the P polarization state) via secondary transformation of the quarter wave plate 20. The foresaid second waveband can be interpreted as other color light different from the first waveband (which means the blue light beam).

Please refer to the embodiments shown in FIG. 1, FIG. 3 and FIG. 4. An upper section and a lower section (or can be interpreted as a right section and a left section) of the polarizing beamsplitter 18A can respectively correspond to the first part 24 and the second part 26 of the collimator lens 14. The first illumination beam B1 emitted from the light source module 12 can be projected onto the upper section of the polarizing beamsplitter 18A, and then be reflected by the polarizing beamsplitter 18A to pass through the first part 24 of the collimator lens 14 towards the wavelength transformation module 16. The first illumination beam B1 can be reflected by the reflection region 28 of the wavelength transformation module 16 in the second direction D2 to pass through the second part 26 of the collimator lens 14 towards the lower section of the polarizing beamsplitter 18A. In the foresaid travel path, the first illumination beam B1 can pass through the quarter wave plate 20A (or the quarter wave plate 20B or the quarter wave plate 20C) to arrive the reflection region 28 of the wavelength transformation module 16, and then be reflected by the reflection region 28 of the wavelength transformation module 16 to pass through the quarter wave plate 20A (or the quarter wave plate 20B or the quarter wave plate 20C) again for transforming into the second illumination beam B2. The second illumination beam B2 can pass through the lower section of the polarizing beamsplitter 18A and be received by the optical diffuser 23.

The first illumination beam B1 emitted from the light source module 12 can be reflected by the polarizing beamsplitter 18A to pass through the first part 24 of the collimator lens 14 towards an actuation region (which may be the first region 30 or the second region 34) of the wavelength transformation module 16, so as to transform into the actuation beam Ba in the second waveband. The actuation beam Ba can pass through the quarter wave plate 20A (or the quarter wave plate 20B or the quarter wave plate 20C), the first part 24 and the second part 26 of the collimator lens 14, and the upper section and the lower section of the polarizing beamsplitter 18A to be received by the optical diffuser 23.

In addition, if the first illumination beam B1 emitted from the light source module 12 is projected onto the lower section of the polarizing beamsplitter 18A, the first illumination beam B1 can be reflected by the polarizing beamsplitter 18A to pass through the second part 26 of the collimator lens 14 towards the wavelength transformation module 16. The reflection region 28 of the wavelength transformation module 16 can reflect the first illumination beam B1 in the second direction D2 to project onto the first part 24 of the collimator lens 14, and the first illumination beam B1 can be transformed into the second illumination beam B2 due to the secondary transformation of the quarter wave plate 20A (or the quarter wave plate 20B or the quarter wave plate 20C), for passing through the upper section of the polarizing beamsplitter 18A and being received by the optical diffuser 23. If the first illumination beam B1 is reflected by the lower section of the polarizing beamsplitter 18A, the first illumination beam B1 can pass through the second part 26 of the collimator lens 14 to project onto the actuation region (which may be the first region 30 or the second region 34) of the wavelength transformation module 16. The actuation region of the wavelength transformation module 16 can be actuated to generate the actuation beam Ba in the second waveband. The actuation beam Ba can pass through the quarter wave plate 20A (or the quarter wave plate 20B or the quarter wave plate 20C), the first part 24 and the second part 26 of the collimator lens 14, and the upper section and the lower section of the polarizing beamsplitter 18A to be received by the optical diffuser 23.

Please refer to the embodiment shown in FIG. 2. The polarizing beamsplitter 18B can be disposed on the position corresponding to the first part 24 or the second part 26 of the collimator lens 14. In this embodiment, the polarizing beamsplitter 18B is disposed on the position corresponding to the first part 24. The quarter wave plate 20 can be disposed on the position corresponding to the first part 24 and the second part 26 of the collimator lens 14, such as the quarter wave plate 20A disposed between the polarizing beamsplitter 18B and the collimator lens 14 (as shown in FIG. 2), or the quarter wave plate 20B optionally disposed between the collimator lens 14 and the wavelength transformation module 16 (as shown in FIG. 3), or the quarter wave plate 20C optionally disposed on the reflection region 28 of the wavelength transformation module 16 (as shown in FIG. 4).

The polarizing beamsplitter 18B can reflect the first illumination beam B1 with the first polarization state, and allow passing of the actuation beam Ba. The second illumination beam B2 with the second polarization state does not pass through the polarizing beamsplitter 18B, so that the polarizing beamsplitter 18B cannot be coated by the filtering layer that allows passing of the light beam in the first waveband, as mentioned above. The first illumination beam B1 emitted from the light source module 12 can be projected onto the polarizing beamsplitter 18B, and then be reflected to pass through the first part 24 of the collimator lens 14 and the quarter wave plate 20A (or the quarter wave plate 20B or the quarter wave plate 20C in other embodiments) towards the wavelength transformation module 16. The reflection region 28 of the wavelength transformation module 16 can reflect the first illumination beam B1 in the second direction D2; the polarization state of the first illumination beam B1 can be different from the first polarization state due to one pass of the quarter wave plate 20A or 20B or 20C. The foresaid first illumination beam B1 can further pass through the quarter wave plate 20A (or the quarter wave plate 20B or the quarter wave plate 20C in other embodiments) to transform into the second illumination beam B2 with the second polarization state, and the second illumination beam B2 can pass through the second part 26 of the collimator lens 14 to surround by the polarizing beamsplitter 18B for being received by the optical diffuser 23. The actuation region (which may be the first region 30 or the second region 34) of the wavelength transformation module 16 can be actuated to generate the actuation beam Ba in the second waveband. The actuation beam Ba can pass through the quarter wave plate 20A (or the quarter wave plate 20B or the quarter wave plate 20C in other embodiments), the first part 24 and the second part 26 of the collimator lens 14, and the polarizing beamsplitter 18B to be received by the optical diffuser 23.

In conclusion, the alignment module of the present invention can utilize feature of the illumination beam with a specific polarization state passing through the quarter wave plate twice to transform into the illumination beam with another polarization state, and feature of the quarter wave plate that allows passing of the actuation beam with the small-sized polarizing beamsplitter (which simultaneously corresponds to the left portion and the right portion of the collimator lens) to pass the illumination beam through the quarter wave plate back and forth for the double transformation, so as to provide light splitting and mixing functions via the polarizing beamsplitter for decreasing a number of optical components and manufacturing cost of the projection apparatus.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An alignment module comprising:
a light source module adapted to emit a first illumination beam with a first polarization state in a first direction;
a collimator lens having a first part, a second part, and an axle located between the first part and the second part;
a wavelength transformation module adapted to receive the first illumination beam from the collimator lens, so as to alternately generate an actuation beam and reflect the first illumination beam, the actuation beam being transmitted towards the collimator lens in a second direction, the first illumination beam being reflected towards the collimator lens in the second direction, the second direction being perpendicular to the first direction;
a polarizing beamsplitter disposed on position corresponding to at least one of the first part and the second part, and adapted to reflect the first illumination beam with the first polarization state and allow passing of the actuation beam; and
a quarter wave plate disposed between the polarizing beamsplitter and the wavelength transformation module, the first illumination beam with the first polarization state passing through the quarter wave plate towards the wavelength transformation module, and being reflected by the wavelength transformation module to pass through the quarter wave plate so as to transform into a second illumination beam with a second polarization state.

2. The alignment module of claim 1, wherein the first illumination beam and the second illumination beam are set in a first waveband, and the actuation beam is set in a second waveband different from the first waveband.

3. The alignment module of claim 1, wherein the polarizing beamsplitter is disposed on position corresponding to the first part and the second part, and is adapted to reflect the first illumination beam and allow passing of the second illumination beam, the first illumination beam passes through the collimator lens towards the wavelength transformation module in a direction opposite to the second direction, and the first illumination beam is reflected in the second direction to pass through the first part and the second part of the collimator lens.

4. The alignment module of claim 1, wherein the polarizing beamsplitter is disposed on position corresponding to the first part and is adapted to reflect the first illumination beam, the first illumination beam passes through the first part of the collimator lens towards the wavelength transformation module in a direction opposite to the second direction, and the first illumination beam is reflected in the second direction to pass through the second part of the collimator lens.

5. The alignment module of claim 1, wherein the quarter wave plate is disposed on position corresponding to the first part and the second part, and further disposed between the polarizing beamsplitter and the collimator lens.

6. The alignment module of claim 1, wherein the quarter wave plate is disposed on position corresponding to the first part and the second part, and further disposed between the collimator lens and the wavelength transformation module.

7. The alignment module of claim 1, wherein the quarter wave plate is disposed on a reflection region of the wavelength transformation module.

8. The alignment module of claim 1, wherein the axle is a central axle of the collimator lens.

9. The alignment module of claim 1, wherein the wavelength transformation module comprises a first region and a reflection region, the first region has a first wavelength transformation layer adapted to receive the first illumination beam and generate the actuation beam, the reflection region is disposed adjacent to the first region and adapted to reflect the first illumination beam incident from the first part of the collimator lens towards the second part of the collimator lens.

10. The alignment module of claim 9, wherein the first wavelength transformation layer comprises yellow wavelength transformation material, and the wavelength transformation module is rotatable.

11. The alignment module of claim 9, wherein the wavelength transformation module further comprises a second region disposed adjacent to the first region and having a second wavelength transformation layer adapted to receive the first illumination beam and generate the actuation beam, the first wavelength transformation layer comprises yellow wavelength transformation material, and the second wavelength transformation layer comprises green wavelength transformation material.

12. The alignment module of claim 9, wherein the wavelength transformation module further comprises a second region disposed adjacent to the first region and having a second wavelength transformation layer adapted to receive the first illumination beam and generate the actuation beam, the first wavelength transformation layer comprises green wavelength transformation material, and the second wavelength transformation layer comprises red wavelength transformation material or orange wavelength transformation material.

13. The alignment module of claim 1, further comprising:
an optical diffuser disposed on position corresponding to the wavelength transformation module, and adapted to receive the actuation beam from the first part and the second part, and further receive the second illumination beam from at least one of the first part and the second part.

14. The alignment module of claim 1, further comprising:
a color wheel disposed on a front optical path relative to the optical diffuser.

15. The alignment module of claim 2, wherein the first waveband provides a blue light beam, and the second wave provides a yellow light beam, or a green light beam or a red light beam or an orange light beam.

16. The alignment module of claim 1, wherein the polarizing beamsplitter is adapted to reflect a blue light beam with the first polarization state, and allow passing of other color light beam and the blue light beam with the second polarization state.
